(19) United States
(12) Patent Application Publication
(10) Pub. No.: US 2025/0209791 A1
(43) Pub. Date: Jun. 26, 2025

(54) METHOD AND SYSTEM FOR GENERATING EVENT FOR OBJECT ON SCREEN BY RECOGNIZING SCREEN INFORMATION INCLUDING TEXT AND NON-TEXT IMAGES ON BASIS OF ARTIFICIAL INTELLIGENCE

(71) Applicant: Infofla Inc., Seoul (KR)

(72) Inventor: In Mook Choi, Seongnam-si (KR)

(21) Appl. No.: 18/848,676

(22) PCT Filed: Mar. 23, 2023
(86) PCT No.: PCT/KR2023/003341

§ 371 Date: Sep. 19, 2024

(30) Foreign Application Priority Data
Mar. 24, 2022 (KR) 10-2022-0036637

(51) Int. Cl. G06V 10/764; G06F 9/54; G06T 7/70; G06V 10/774; G06V 10/82; G06V 20/62

(52) U.S. Cl. CPC G06V 10/764; G06F 9/542; G06T 7/70; G06V 10/774; G06V 10/82; G06V 20/62; G06T 2207/20081; G06T 2207/20084

(57) ABSTRACT

A method of generating an event for an object on a screen by recognizing screen information based on AI includes accessing a Web-based IT operation management system platform to register a schedule in a scheduler, reporting registration of the schedule to an AI Web Socket of the Web-based IT operation management system platform, transmitting data reporting start of the scheduler from the AI Web Socket of the Web-based IT operation management system platform to an AI Web Socket of an AI screen agent of a PC through communication at a predetermined time, transmitting a PC screen image, and requesting information data, inferring a position of one or more objects on the screen, transmitting information data for the inferred position of the one or more objects, and generating an event for the one or more objects on the PC screen based on the transmitted data.

### RELATED APPLICATIONS

This application is the national stage of International Application No. PCT/KR2023/003341, filed on Mar. 23, 2023, which claims the benefit of priority based on Korean Application No. 10-2022-0036637, filed on Mar. 24, 2022. The contents and disclosures of these applications are incorporated herein by reference in their entirety.

### TECHNICAL FIELD

The present disclosure relates to a method and system for generating an event for an object on a screen using a method of recognizing screen information based on artificial intelligence (AI), and more particularly to a method and system for generating an event of an RPA input object on a display screen using a screen content inference method based on AI.

### BACKGROUND ART

In RPA (Robotic Process Automation), software robots take over repetitive tasks previously performed by humans.

A conventional art Korean Patent Publication No. 10-2020-0127695 discloses that, when a task is transmitted to an RPA robot through a chatbot, the RPA robot may drive a Web browser on a PC screen to find information and deliver the information back to the chatbot. At this time, as a method of recognizing a search box, a search button, etc. of a Web browser by the RPA robot, a class ID, etc. of the search box, the search button, etc. learned in advance is found from sources of HTML and JAVASCRIPT, which are Web scripting languages, to find whether the search box, the search button, etc. is present on the screen, text such as a search term is input to the class ID of the search box when the search box, the search button, etc. is present, and a mouse click event is input to the class ID of the search button to operate the Web browser.

### DISCLOSURE

### Technical Problem

Recently, in an increasing number of cases, a Web page is configured to change a class ID of HTML each time to address security and RPA. In this case, research has been conducted to solve, through an AI learning model, the case where the RPA robot cannot find the learned class ID, making recognition and input impossible.

However, even though event clicks are possible through screen UI recognition using an AI learning model, there has been difficulty in UI recognition since text cannot be recognized in images containing text images.

Various studies are being conducted to increase a recognition rate for a screen UI such as an icon, a Web browser, or a search button on a screen. However, a method of recognizing a screen currently being developed has a disadvantage of being unable to recognize text in an image such as icon text or application title text even though a non-text screen UI such as an icon, a Web browser, or a search button on a screen may be recognized.

### Technical Solution

A method and device for adjusting a screen according to an embodiment of the present invention for solving the above-described problem may perform RPA input object detection and text recognition of a UI screen on a display based on AI technology.

Specifically, a method of generating an event for an RPA input object on a screen by recognizing screen information including images having text and non-text based on AI includes accessing a Web-based IT operation management system platform from a PC to register a schedule in a scheduler, reporting registration of the schedule to an AI Web Socket of the Web-based IT operation management system platform when the schedule is registered in the scheduler, transmitting data reporting start of the scheduler from the AI Web Socket of the Web-based IT operation management system platform to an AI Web Socket of an AI screen agent of the PC through communication at a predetermined time, transmitting, by the AI screen agent, a screen image of the PC including images having text and non-text to an AI screen of the Web-based IT operation management system platform, and requesting information data obtained by inferring a position of an RPA input object on the screen from the AI screen including an AI model trained using an RPA input object position from a screen image, inferring, by the AI screen, a position of an RPA input object on the screen through the trained AI model of the AI screen from the screen image including the received images having the text and non-text, transmitting information data for the inferred position of the RPA input object to the AI Web Socket of the AI screen agent through communication, and generating, by the AI screen agent, an event for the RPA input object on the screen of the PC based on the transmitted data, wherein the AI model of the AI screen outputs result data obtained by inferring an RPA input object position at which an event of an RPA input object is to be generated on the entire screen using, as training data, images of the entire screen and positions of RPA input objects labeled on images having text and non-text on the entire screen, and the inferring, by the AI screen, a position of an RPA input object on the screen through the trained AI model of the AI screen from the screen image including the received images having the text and non-text includes distinguishing between a part including the text and a part which is not the text in the images having the text and non-text so that the AI model of the AI screen detects the images having the text and non-text, and recognizing text from a part of the image including the text.

In another embodiment of the present invention, in the inferring a position of an RPA input object on the screen through the trained AI model of the AI screen, the AI model may be trained to perform a function of an RPA input object detector configured to provide information on what type of RPA input object is present (classification) at which position (localization) on one screen in order to distinguish between a part including the text and a part which is not the text in the images having the text and non-text, and the RPA input object detector may be a 1-stage detector configured to simultaneously perform a localization stage and a classification stage.

In another embodiment of the present invention, the 1-stage detector may be an SSD (Single Shot MultiBox Detector), a YOLO detector, or a DSSD (Deconvolutional Single Shot Detector).

In another embodiment of the present invention, in the inferring a position of an RPA input object on the screen through the trained AI model of the AI screen, the AI model may utilize a convolutional recurrent neural network (C-RNN) model to recognize text from a part of the image including the text.

In another embodiment of the present invention, a method of generating an event for an RPA input object on a screen by recognizing screen information including images having text and non-text based on AI in a PC including an AI screen agent may include inferring, by an AI screen, a position of an RPA input object on the screen through a trained AI model of the AI screen from a screen image, the AI screen agent in the PC including the AI screen having the AI model trained using the RPA input object position from the screen image including the images having text and non-text of the PC, and generating, by the AI screen agent, an event for an RPA input object on the screen of the PC based on the position of the RPA input object inferred by the AI screen in the AI screen agent, wherein the AI model of the AI screen outputs result data obtained by inferring an RPA input object position at which an event for the RPA input object is to be generated from the entire screen using, as training data, a position of the RPA input object labeled in images of the entire screen and images including text and non-text of the entire screen, and the inferring, by an AI screen, a position of an RPA input object on the screen through a trained AI model of the AI screen from a screen image includes distinguishing between a part including the text and a part which is not the text in the images having the text and non-text so that the AI model of the AI screen detects the images having the text and non-text, and recognizing text from a part of the image including the text.

In another embodiment of the present invention, the method may further include accessing a Web-based IT operation management system platform from the PC to register a schedule in a scheduler, reporting registration of the schedule to an AI Web Socket of the Web-based IT operation management system platform when the schedule is registered in the scheduler, and transmitting data reporting start of the scheduler from the AI Web Socket of the Web-based IT operation management system platform to an AI Web Socket of the AI screen agent of the PC through communication at a predetermined time.

In another embodiment of the present invention, the RPA input object may include one or more of a console window, a window, and a dialog box, selectable links, and selectable buttons. Additionally it may include one or more of input locations where information can be entered, such as cursor positions, ID input positions, password input positions, and search bar input positions, and mouse click positions.

In another embodiment of the present invention, the RPA input object may be a password input unit.

In another embodiment of the present invention, the Web-based IT operation management system platform may be installed in a cloud server.

In another embodiment of the present invention, a program programmed to perform the method of generating an event for an RPA input object on a screen by recognizing screen information including text and non-text images based on AI using a computer may be stored in a computer-readable recording medium.

In another embodiment of the present invention, a system for generating an event for an RPA input object on a screen by recognizing screen information based on AI includes a PC including an AI screen agent, and a server including a Web-based IT operation management system platform, wherein the AI screen agent accesses the Web-based IT operation management system platform to register a schedule in a scheduler, the server reports registration of the schedule to an AI Web Socket of the Web-based IT operation management system platform in the server when the schedule is registered in the scheduler, and transmits data reporting start of the scheduler from the AI Web Socket of the Web-based IT operation management system platform to an AI Web Socket of an AI screen agent of the PC through communication at a predetermined time, the AI screen agent of the PC transmits a screen image of the PC including images having text and non-text to an AI screen of the Web-based IT operation management system platform, and requests information data obtained by inferring a position of one or more RPA input objects on the screen from the AI screen including an AI model trained using an RPA input object position from a screen image, the AI screen infers a position of an RPA input object on the screen through the trained AI model of the AI screen from the screen image including the received images having the text and non-text, and transmits information data for the inferred position of the RPA input object to the AI Web Socket of the AI screen agent through communication, the AI screen agent generates an event for one or more RPA input objects on the PC screen based on the transmitted data, the trained AI model outputs result data obtained by inferring an RPA input object position at which an event of an RPA input object is to be generated on the entire screen using, as training data, images of the entire screen and positions of RPA input objects labeled on images having text and non-text on the entire screen, and the AI model of the AI screen distinguishes between a part including the text and a part which is not the text in the images having the text and non-text to detect the images having the text and non-text, and recognizes text from a part of the image including the text.

In another embodiment of the present invention, a RPA input object control device for generating an event for an RPA input object on a screen by recognizing screen information based on AI in a computer includes an AI screen agent, wherein the AI screen agent includes a data collector configured to cause a position of an RPA input object displayed on a computer screen including images having text and non-text to be learned, and to collect data on the entire screen and position data of the RPA input object displayed on the screen including images having text and non-text from a display device of the computer to generate an event for the RPA input object, an AI model learner trained through a deep neural network based on collected data, a RPA input object detector configured to detect an RPA input object in the screen based on a result of training in the AI model learner, and a RPA input object controller configured to generate an event for an RPA input object based on an RPA input object position on the entire screen detected and classified in the RPA input object detector, an AI model trained from the AI model learner outputs result data obtained by inferring an RPA input object position at which an event of an RPA input object is to be generated on the entire screen using, as training data, images of the entire screen and positions of RPA input objects labeled on images having text and non-text of the entire screen, and the AI model distinguishes between a part including the text and a part which is not the text in the images having the text and non-text to detect the images having the text and non-text, and recognizes text from a part of the image including the text.

In another embodiment of the present invention, the AI model may be trained to perform a function of an RPA input object detector configured to provide information on what type of RPA input object is present (classification) at which position (localization) on one screen to distinguish between a part including the text and a part which is not the text in the images having the text and non-text, and the AI model may utilize a C-RNN model to recognize text from a part of the image including the text.

In addition, other methods, other systems and computer programs for implementing the present invention may be further provided.

Other aspects, features, and advantages other than those described above will become apparent from the following drawings, claims and detailed description of the invention.

### Advantageous Effects

In the present disclosure, to solve the existing RPA problems, a data learner may generate an AI screen model capable of learning and recognizing screen-related data of various devices such as PCs, that is, data of various RPA input objects that may appear on a screen such as a browser, a search box, and a search button.

In a server, a scheduler may operate at a certain time to instruct an AI agent, which is executed in the form of a program or an application in a user terminal, a notebook, and a desktop computer, to operate through TCP/IP socket communication such as a Web Socket, and transmit a screen picture of the AI agent to an AI screen model located in the server or a PC thereof to predict a desired RPA input object through a trained model.

A predicted data value may be transmitted to the AI agent through socket communication to control and process input of text data or input of mouse button click on coordinates of a user PC screen, and screen recognition and screen coordinate input control may be repeated so that AI may automatically perform a task performed by a human on a screen of a user PC, etc.

When the present disclosure is used, it is possible to support all environments such as the web, command line, RDP (Remote Desktop Protocol), etc. by determining from a screen picture whether an RPA input object such as an expected browser, image, input window (input space), etc. is present on a screen. Further, it is possible to directly input text data and click a button using coordinates of the screen, and thus input such as data input or mouse click is allowed in most environments. Therefore, it is possible to recognize a screen and control input in most devices, each using a screen connected to a network, such as a PC, IoT, a connected car terminal, or a kiosk.

The present disclosure has an advantage in that screen recognition AI technology may allow RPA input objects of various programs on a screen to be learned. While RPA has restrictions on an environment (Web, CLI, RDP, etc.) supported by a product-specific feature, the screen recognition AI technology may recognize all RPA input objects appearing on the screen. In addition, while RPA requires a reference value referred to as an anchor to find an RPA input object such as an input box or a button in a browser, the screen recognition AI technology may directly recognize and access an RPA input object without an anchor.

Existing RPA mainly uses the Web due to the nature of task automation on a PC, and mainly searches for text in html to understand the Web rapidly and better. However, there has been a problem in that the existing RPA operates when html is changed like security html. When the screen recognition AI technology of the present disclosure is used, an RPA input object may be recognized on a screen without searching for security html even when html is changed like security html. In addition, since an RPA input object is recognized by viewing a screen provided by an OS regardless of operating system such as Web, Windows, macOS, or Linux, RPA input object recognition technology using AI of the present disclosure is operable.

In addition, in the case of RDP, RPA uses an API of a specific RDP product to obtain RPA input object information on a screen, whereas screen recognition AI technology may recognize an RPA input object on a screen without the need of any API of an RDP product.

Using the present disclosure, it is possible to automate a series of human actions through continuous recognition of RPA input objects and input of letters/buttons to screen coordinates.

### DESCRIPTION OF DRAWINGS

FIG. 1 is an exemplary diagram of a RPA input object control system according to an embodiment of the present disclosure;

FIG. 2 is a block diagram of an AI screen agent according to an embodiment of the present disclosure;

FIG. 3 is a flowchart of a RPA input object control process according to an embodiment of the present disclosure;

FIG. 4 is a flowchart for training an AI screen learning model configured to infer a position of an RPA input object on a screen of FIG. 1;

FIG. 5 is an exemplary diagram illustrating a result of inferring a position of an RPA input object through an AI model trained on a browser screen;

FIG. 6 is an exemplary diagram illustrating a result of inferring a position of an RPA input object through a trained AI model on a PC desktop;

FIG. 7A is an exemplary diagram illustrating a screen for training an AI model configured to infer a position of an RPA input object on the screen according to FIG. 4;

FIG. 7B is an exemplary diagram of labeling an RPA input object on the screen for training the AI model configured to infer a position of an RPA input object on the screen according to FIG. 4;

FIG. 7C is an exemplary diagram of a result of actually recognizing an RPA input object after training the AI model configured to infer a position of an RPA input object on the screen according to FIG. 4;

FIG. 7D is an exemplary diagram illustrating a process of training by applying a mask-RCNN from a screen for training of FIG. 7A;

FIG. 8 is an example diagram illustrating screen information including text and non-text images;

FIG. 9A is an example diagram illustrating screen information of a specific portal site including text and non-text images and non-text images;

FIG. 9B is an example diagram illustrating a case where

screen UI images are distinguished based on RPA input object detection according to an embodiment of the present invention;

FIG. 9C is an example diagram illustrating text images that cannot be distinguished only by RPA input object detection according to an embodiment of the present invention;

FIG. 10 is an example diagram illustrating a process of recognizing a text image from a screen image including text and non-text images according to an embodiment of the present invention;

FIG. 11A is an diagram illustrating a case where misrecognition is reduced by recognizing a text image from a screen image including text and non-text images according to an embodiment of the present invention; and

FIG. 11B is an example diagram illustrating a case where a text image may be recognized as error information from a screen image including text and non-text images according to an embodiment of the present invention.

### MODE FOR INVENTION

Advantages and characteristics of the present disclosure, and methods of achieving the advantages and characteristics will become clear with reference to embodiments described in detail in conjunction with the accompanying drawings. However, it should be understood that the present disclosure is not limited to the embodiments presented below, may be implemented in various different forms, and includes all changes, equivalents, and substitutes included in the spirit and technical scope of the present disclosure. The embodiments presented below are provided to complete the disclosure of the present disclosure and to fully inform those skilled in the art of the scope of the invention to which the present disclosure belongs. In describing the present disclosure, when it is determined that a detailed description of a related known technology may obscure the gist of the present disclosure, the detailed description will be omitted.

Terms used in this application are only used to describe specific embodiments, and are not intended to limit the present disclosure. Singular expressions include plural expressions unless the context clearly dictates otherwise. In this application, terms such as “comprise” or “have” are intended to designate that there is a feature, number, step, operation, component, part, or combination thereof described in the specification, and it should be understood that the terms do not preclude the possibility of the presence or addition of one or more other features, numbers, steps, operations, components, parts, or combinations thereof. Terms such as first and second may be used to describe various components. However, components should not be limited by the terms. These terms are only used for the purpose of distinguishing one component from another.

Hereinafter, embodiments according to the present disclosure will be described in detail with reference to the accompanying drawings, and in the description with reference to the accompanying drawings, the same or corresponding components are given the same reference numerals, and redundant descriptions thereof will be omitted.

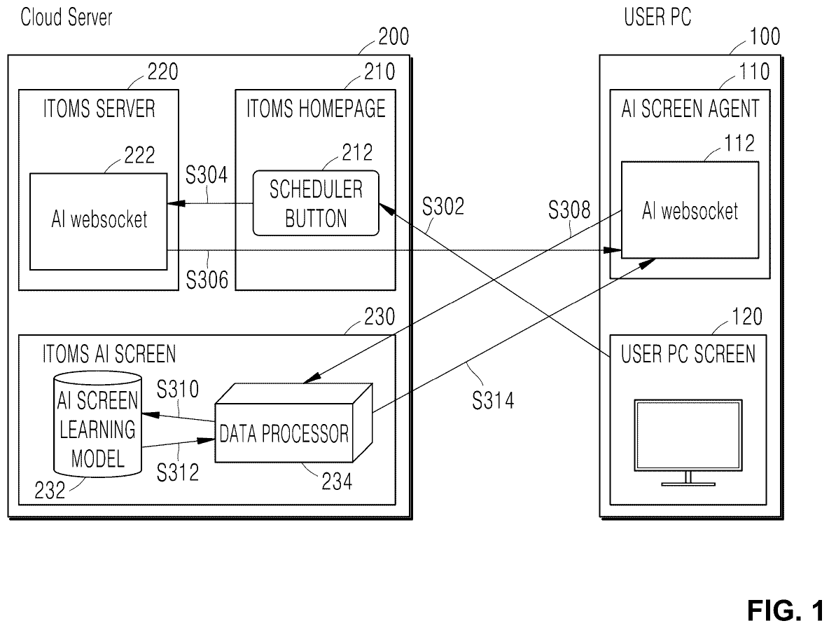

FIG. 1 is an exemplary diagram of a RPA input object control system according to an embodiment of the present disclosure.

The RPA input object control system may include a user PC 100 and a server.

The user PC 100 may include a user PC screen 120 and an AI screen agent 110 displayed on a display. The AI screen agent 110 may include an AI Web Socket 112.

A Web-based IT operation management system platform 200 may include a homepage 210, an AI Web Socket 222, and an AI screen 230 of the Web-based IT operation management system platform 200. The AI screen 230 may include a trained AI model 232.

In another embodiment of the present disclosure, the AI screen 230 may be included in the user PC 100 when the user PC 100 has sufficient computing power.

In the present disclosure, “RPA input object” means any object on the screen that may be activated by an input device such as a mouse or keyboard on the screen. The RPA input object on the screen may be an object to be learned by an AI model. For example, the RPA input object may be a program window (input space) used by a user on a PC screen, an input window (input space) of a conversation window, a search box window (input space) of a browser, various mouse-clickable buttons such as login buttons and subscription buttons, or specific characters or symbols such as logos, IDs, passwords, company names, etc. In the present disclosure, “control” of “RPA input object” refers to every action that generates an event of the RPA input object by activating a program window, entering an input item in a conversation window, entering a search bar in a browser window, entering an ID, entering a password, and entering a company name.

The server may be a cloud server or may be a general independent server. ITOMS is the Web-based IT operation management system platform 200 of Infofla Inc.

The user PC 100 may register a scheduler by accessing the Web-based IT operation management system platform 200 of the server automatically or by the user clicking a scheduler button 212 (S302).

The user PC 100 may register a scheduler by accessing the Web-based IT operation management system platform 200 of the server automatically or by the user clicking the scheduler button 212 (S202).

When the scheduler is registered, the AI Web Socket 222 of the Web-based IT operation management system platform 200 may be notified of registration (S304).

Data indicating start of the scheduler may be transmitted from the AI Web Socket 222 of the Web-based IT operation management system platform 200 to the AI Web Socket 112 in the AI screen agent 110 of the user PC 100 through communication at a predetermined time (S306).

The AI screen agent 110 may transmit an image of the user PC screen 120 to the AI screen 230 of the Web-based IT operation management system platform 200, and request information data obtained by inferring a position of an RPA input object on the screen from the AI screen 230 including the trained AI model 232 (S308). The trained AI model may be an RPA input object position search model that infers a position of an RPA input object generating an event of the RPA input object in the entire screen using, as training data, images of the entire screen and positions of RPA input objects labeled on the images of the entire screen. In general, it is necessary to collect training data to construct AI training data. Such training data may be collected, for example, by collecting PC screen images, setting a bounding box around a main RPA input object using an annotation tool, and performing labeling. For example, by setting a box in the Google search window on the Web screen of the Google search site and labeling the box as Google search window, it is possible to collect data on the entire screen of the Google search site and label data for RPA input objects in the Google search window.

The position of the RPA input object on the screen may be inferred from the received screen image through the trained AI model 232 of the AI screen 230 (S310 and S312).

The Web-based IT operation management system platform 200 may transmit information data on the inferred position of the RPA input object to the AI Web Socket 112 of the AI screen agent 110 through communication (S314).

Based on the transmitted data, for example, an event for an RPA input object may be generated on the user PC screen 120 through the AI screen agent 110 (S316).

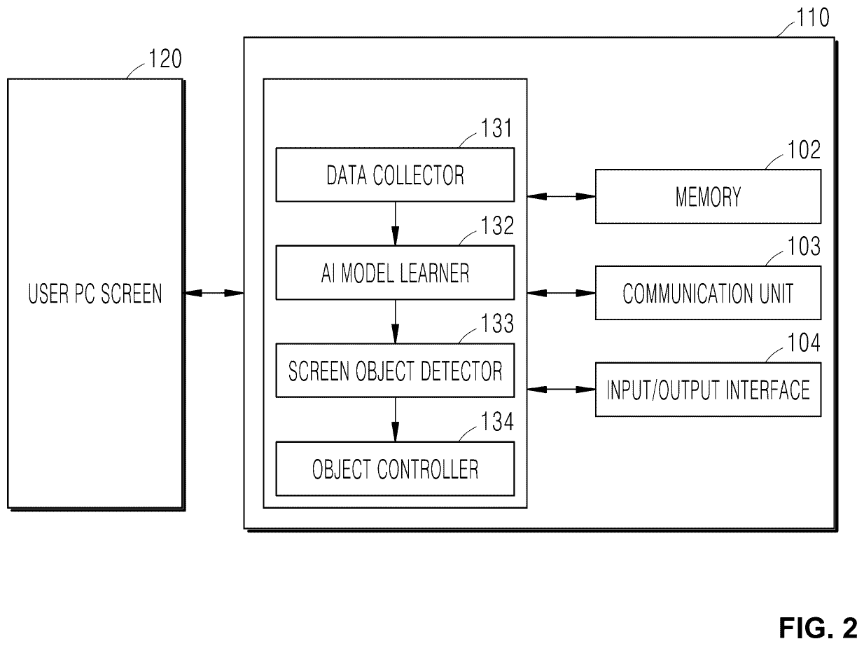

In another embodiment of the present disclosure, the AI screen 230 may be included in the user PC 100. In this case, the AI screen learning model may be autonomously generated without transmitting data to the Web-based IT operation management system platform 200. When the AI screen 230 is included in the user PC 100, in step S308 in which the AI screen agent 110 transmits an image of the user PC screen 120 to the AI screen 230 of the Web-based IT operation management system platform 200 and requests information data obtained by inferring a position of an RPA input object on the screen from the AI screen 230 including the trained AI model 232, and in step S314 in which the Web-based IT operation management system platform 200 transmits the information data on the inferred position of the RPA input object to the AI Web Socket 112 of the AI screen agent 110 through communication, an RPA input object is changed from the ITOMS AI screen 230 in the cloud server 200 to the ITOMS AI screen in the user PC 100, and on the ITOMS AI screen of the AI screen agent 110, a data collector 131, an AI model learner 132, and an RPA input object detector 133 of FIG. 2 perform the same functions as those of the ITOMS AI screen 230.

When the AI screen 230 is included in the user PC 100, a method of generating an event for an RPA input object on a screen by recognizing screen information based on AI may include accessing a Web-based IT operation management system platform from a user PC to register a schedule in a scheduler, reporting registration of the schedule to an AI Web Socket of the Web-based IT operation management system platform when the schedule is registered in the scheduler, transmitting data reporting start of the scheduler from the AI Web Socket of the Web-based IT operation management system platform to an AI Web Socket of an AI screen agent of a user PC through communication at a predetermined time, transmitting, by the AI screen agent, a user PC screen image to an AI screen of the Web-based IT operation management system platform, and requesting information data obtained by inferring a position of one or more RPA input objects on the screen from the AI screen including an AI model trained using an RPA input object position from a screen image, inferring a position of one or more RPA input objects on the screen through the trained AI model of the AI screen from the screen image received by the AI screen, transmitting information data for the inferred position of the one or more RPA input objects to the AI Web Socket of the AI screen agent through communication, and generating, by the AI screen agent, an event for the one or more RPA input objects on the user PC screen based on the transmitted data, and the AI model of the AI screen may output result data obtained by inferring an RPA input object position at which an event of one or more RPA input objects is to be generated on the entire screen using, as training data, images of the entire screen and a position of an RPA input object labeled in one or more images on the entire screen.

FIG. 2 is a block diagram of the AI screen agent according to an embodiment of the present disclosure.

The RPA input object control system may be constructed as a RPA input object control device in the user PC 100 without the Web-based IT operation management system platform 200.

The RPA input object control device includes a scheduler registration unit (not illustrated) and the AI screen agent 110, and the AI screen agent 110 may include a function of causing a position of an RPA input object displayed on the screen to be learned and generating an event for the RPA input object. To autonomously cause an RPA input object position to be learned, the AI screen agent 110 may include a data collector 131 configured to collect data on the entire screen from a display device, an AI model learner 132 configured to be trained through a deep neural network based on the collected data, and a RPA input object detector 133. The AI screen agent 110 may include a RPA input object controller 134, a memory 102 configured to store various data such as video screen-related data, and training data, a communication unit 103 configured to communicate with a server or an external device, and an input/output adjuster 104.

The scheduler registration unit that registers the schedule serves to notify the AI screen agent 110 of registration of the scheduler and report start of the scheduler in the user PC 100 at a predetermined time.

According to notification of the scheduler registration unit, the data collector 131 of the AI screen agent 110 may collect data related to the entire screen on the PC screen 120 on the display. The RPA input object detector 133 may detect positions of RPA input objects on the entire screen with respect to data collected through the trained AI learning model.

The AI model learner 132 is trained to infer a position of an RPA input object on the entire screen using images of the PC screen and specific positions of RPA input objects labeled on the images of the PC screen as data for training (or training data set). The AI model learner 132 may include a processor specialized for parallel processing such as an NPU. For learning of an RPA input object position, after the AI model learner 132 stores data for training in the memory 102, the NPU collaborates with the memory 102 to cause the RPA input object position to be learned to generate a trained AI model in the RPA input object detector 133, and new data for training is learned at a specific time or periodically in response to collection of the new data for training, so that it is possible to continuously improve the AI learning model.

In an embodiment of the present disclosure, the AI model learner 132 may stop functioning when a trained AI model is generated in the RPA input object detector 133, until new data for training is collected in the data collector 131. In this case, the data collector 131 and the AI model learner 132 stop functioning, and the screen image received from the user PC screen may be directly transferred to the RPA input object detector 133. The new AI model learner 132 creates an AI model using supervised learning. However, one or more RPA input objects may be learned using unsupervised learning or reinforcement learning.

The RPA input object detector 133 may detect whether a desired RPA input object is present on the screen and a position of one RPA input object and detect a plurality of RPA input object positions through a trained AI model in the AI model learner 132. The trained AI model uses, as training data, images on the entire screen and positions of RPA input objects labeled on one or more images on the entire screen, and outputs result data obtained by inferring an RPA input object position at which an event of one or more RPA input objects is to be generated on the entire screen. In another embodiment of the present disclosure, as described above, the RPA input object detector 133 may be configured to detect and classify a position of an RPA input object on the user PC screen 120 through the trained AI model transmitted from the server.

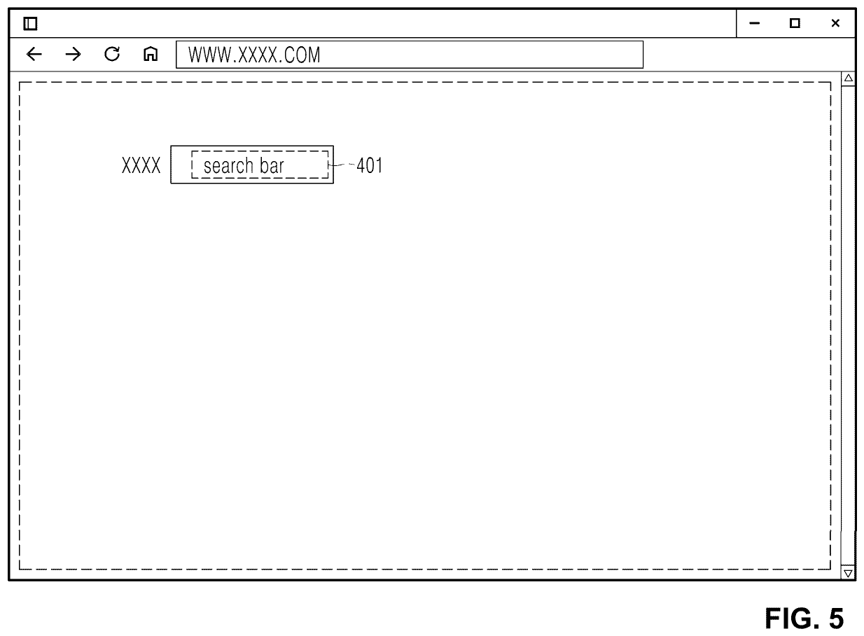

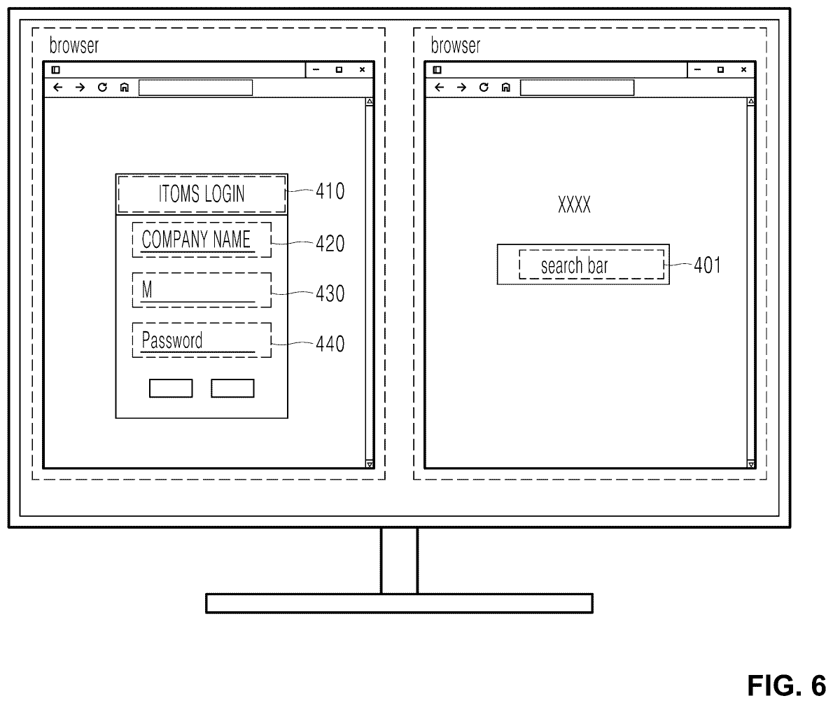

The RPA input object controller 134 may generate an event for an RPA input object based on a position of the RPA input object on the entire screen detected and classified by the RPA input object detector 133. The RPA input object controller 134 may perform a control operation to automate a series of human actions through continuous recognition of RPA input objects and text/button input to screen coordinates. For example, as illustrated in FIG. 5, the RPA input object controller 134 may detect a search bar 401 on the browser and generate an event for searching for a desired search query. In addition, as illustrated in FIG. 6, the RPA input object controller 134 may detect a login 410 dialog window in several program windows on the PC desktop, detect input positions of an ID and a password, a position of the search bar 401 on a search box browser, various buttons, etc., and input a desired company name 420, ID 430, and password 440 or generate an event of searching for a search query.

When the AI screen agent 110 is included in a user terminal, a laptop computer, or a desktop computer in the form of a program or an application, the AI screen agent 110 may communicate with an external device such as a server using the communication unit 103 of the user terminal, the laptop computer, or the desktop computer through the communication unit 103.

In another embodiment, the AI screen agent 110 may access the Web-based IT operation management system platform outside the user PC to receive RPA input object position information data learned from the Web-based IT operation management system platform, thereby generating an event for an RPA input object on the screen. In this case, the data collector 131, the AI model learner 132, and the RPA input object detector 133 are not used, and the Web-based IT operation management system platform 200 includes the data collector 131, the AI model learner 132, and the RPA input object detector 133 to train the AI screen model. Further, the AI screen agent 110 may generate an event for an RPA input object by transmitting the user PC screen image to the Web-based IT operation management system platform 200 through the communication unit 103 and receiving RPA input object position information data.

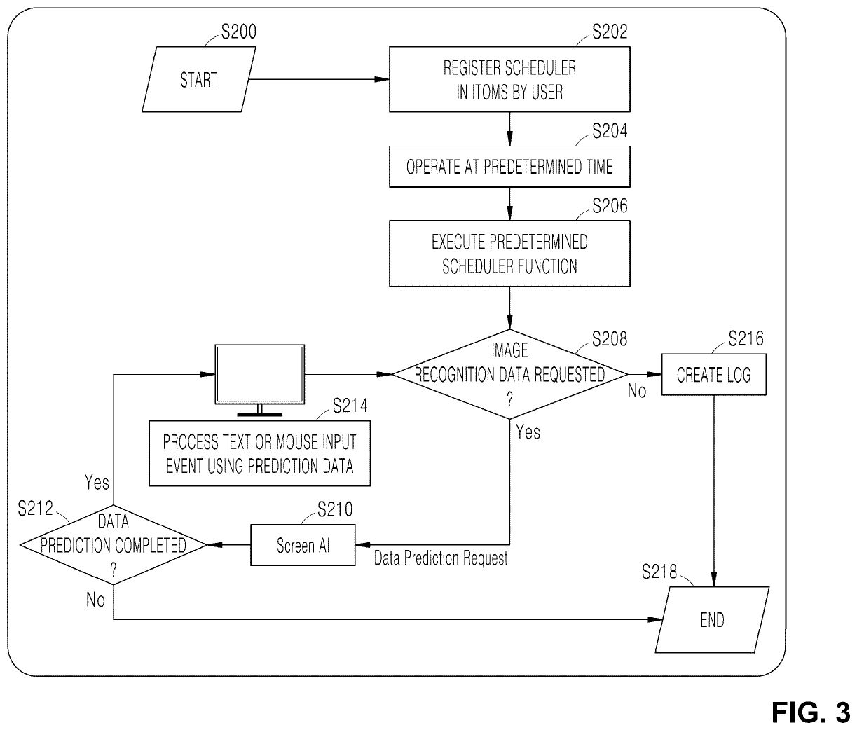

FIG. 3 is a flowchart of a RPA input object control process according to an embodiment of the present disclosure.

When RPA input object control of the AI screen is started in a terminal such as the user PC 100 that requires screen recognition (S200), a scheduler may be registered by accessing the Web-based IT operation management system platform 200 of the server automatically or by the user clicking the scheduler button 212 (S202).

When the scheduler is registered, registration of the scheduler may be reported to the AI Web Socket 222 of the Web-based IT operation management system platform 200. According to registration of the scheduler, the Web-based IT operation management system platform 200 may operate at a predetermined time (S204), execute a predetermined scheduler function (S206), and transmit data indicating start of the scheduler from the AI Web Socket 222 of the Web-based IT operation management system platform 200 to the AI Web Socket 112 of the AI screen agent 110 of the user PC 100 through communication at a predetermined time.

The AI screen agent 110 may transmit an image of the user PC screen 120 to the AI screen 230 of the Web-based IT operation management system platform 200, and request information data obtained by inferring a position of an RPA input object on the screen from the AI screen 230 including the trained AI model 232.

It is determined whether there is a request for image recognition data from the PC 100 (S208), and when there is a request for image recognition data from the PC 100, the position of the RPA input object on the screen may be inferred through the trained AI model 232 of the AI screen 230 from the received screen image until the data request is completed (S212). Further, the Web-based IT operation management system platform 200 may transmit information data on the inferred position of the RPA input object to the AI Web Socket 112 of the AI screen agent 110 through communication, and the AI screen agent 110 of the PC 100 generates an event for an RPA input object on the user PC screen 120 based on the transmitted data, and processes a text or mouse input event (S214).

When there is no request for image recognition data from the PC 100, a log is created when all given processes are processed or when an error occurs (S216), and RPA input object control of the AI screen 230 is ended.

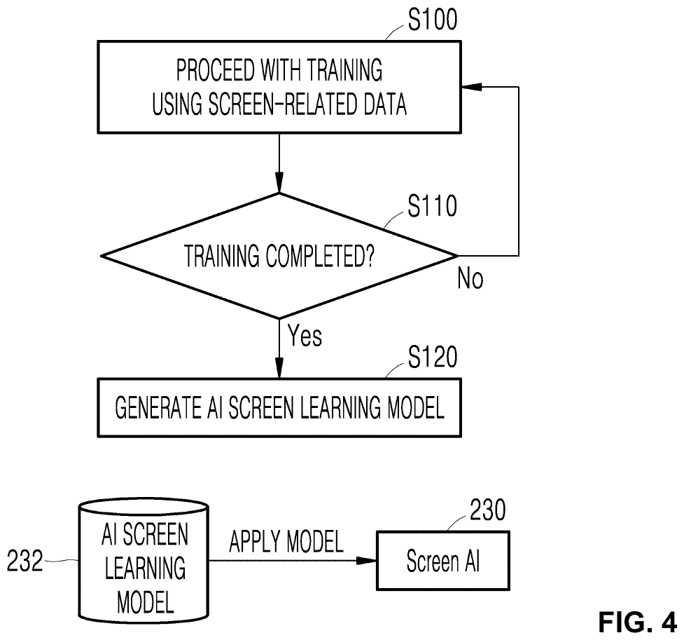

FIG. 4 is a flowchart for training an AI screen learning model configured to infer a position of an RPA input object on the screen of FIG. 1.

Referring to FIG. 4, AI model training for inferring the position of the RPA input object on the screen is started in the AI screen agent 110 or on the AI screen 230 (S100). AI model training may be performed in any one form among supervised learning, unsupervised learning, and reinforcement learning.

AI model training proceeds using data for AI model training including data related to a screen image on the user PC screen 120 and data obtained by labeling the data with an RPA input object position (S110). When training is completed (S110), an AI screen learning model is generated. The data collector 131 of the AI screen 230 or the AI screen agent 110 may generate a screen image data value and RPA input object positions labeled for the screen image data value as data for AI training and data for testing at regular intervals. A ratio of the data for training and the data for testing may vary according to the amount of data, and may generally be set to a ratio of 7:3. The data for training may be collected and stored for each RPA input object, and an actual screen used may be collected through a capture application. In collecting and storing the training data, a screen image may be gathered and stored in the server 200. Data for training the AI model may undergo data preprocessing and data augmentation processing to obtain an accurate training result. To obtained a result of FIG. 5, training of the AI model may be performed by configuring a training data set using screen image data values on the user PC screen 120 displayed on a browser site as input data and data obtained by labeling positions of RPA input objects such as search windows and clickable icons as output data.

An AI model, for example, an artificial neural network such as a mask-RCNN or an SSD is trained using positions of RPA input objects on the entire screen using training data collected through supervised learning (S100). In an embodiment of the present disclosure, a deep learning-based screen analyzer may be used. For example, it is possible to tune and use an AI learning model based on TensorFlow, which is an AI language library used for AI programming, or MobileNetV1/MobileNetV2 of Keras.

A CNN (Convolutional Neural Network) is the most representative method of deep neural networks, and characterizes images from small features to complex features. The CNN is an artificial neural network having a structure in which preprocessing is performed in a convolutional layer, which includes one or several convolutional layers and general artificial neural network layers placed thereon. For example, in order to cause human face images to be learned through the CNN, one convolution layer is created by first extracting simple features using a filter, and then a new layer extracting more complex features from these features, for example, a polling layer is added. The convolution layer is a layer that extracts features through a convolution operation, and performs multiplication having a regular pattern. The polling layer is a layer that abstracts an input space and reduces the dimension of an image through subsampling. For example, a face image having a size 28×28 may be compressed into 12×12 through subsampling (or pooling) by creating feature maps of 24×24 each using four filters having a screen of 1. In a next layer, 12 feature maps are created with a size of 8×8, subsampling is performed again with 4×4, and a neural network having input of 12×4×4=192 is finally trained to detect the image. In this way, several convolution layers are connected to extract the features of the and image, finally, the same error backpropagation neural network as before may be used for training. The CNN is advantageous in autonomously creating a filter that characterizes features of an image by training an artificial neural network.

RPA input objection detection is a subfield of computer vision, and performs a task of detecting a specific meaningful RPA input object within the entire digital image and video. This RPA input object detection may be used to solve problems in various fields such as image retrieval, image annotation, face detection, and video tracking. In the present disclosure, RPA input object detection provides information on what type of RPA input objects (classification) exist at which locations (localization) for RPA input objects classified as “RPA input objects” within a screen (or image).

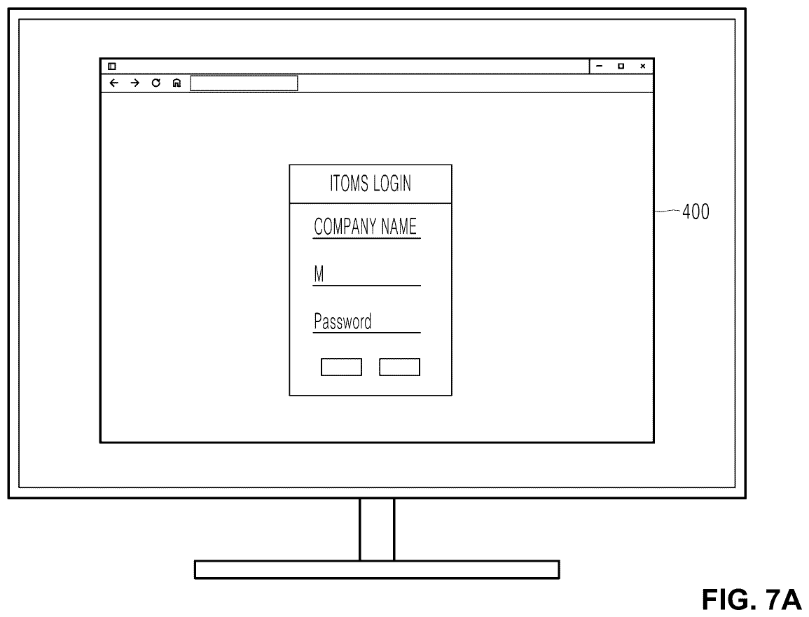

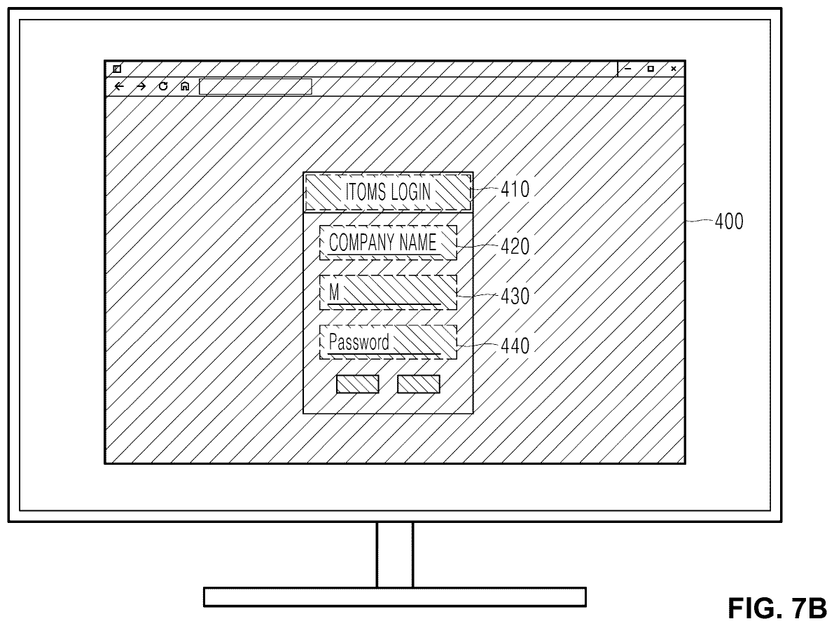

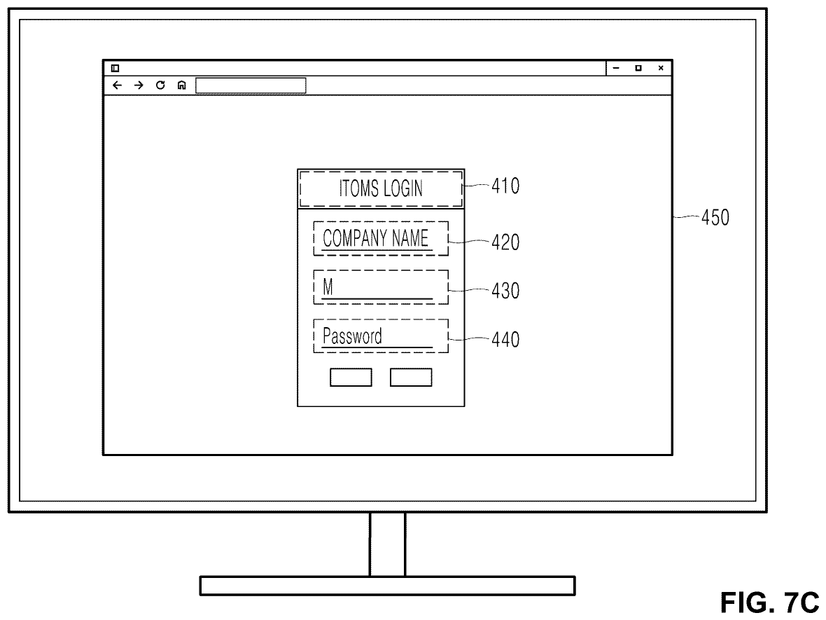

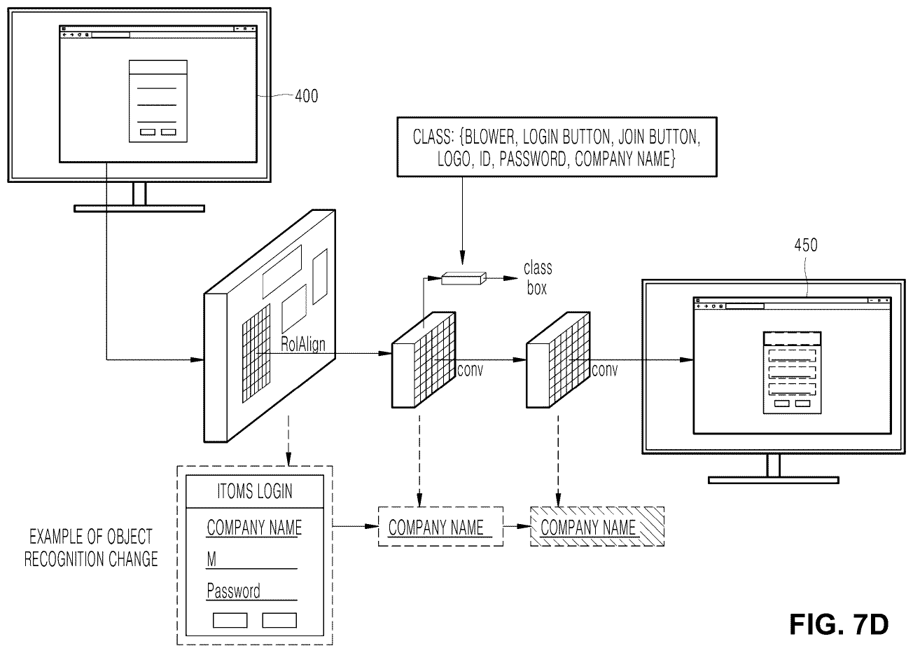

RPA input object detection includes two parts. A first part is localization for finding a position where an RPA input object is present, and a second part is classification for checking what RPA input object is present at the corresponding location. In general, a deep learning network of RPA input object detection is divided into a 2-stage detector and a 1-stage detector. In short, localization and classification are separately performed in a 2-stage detector, and simultaneously performed in a 1-stage detector. In 2-Stage, regions presumed to have an RPA input object are first selected, and classification is performed for each of the regions. In 1-Stage, this process is performed simultaneously, and thus has an advantage of being faster. Originally, among 2-Stage and 1-Stage, while 2-Stage has high accuracy and low speed, 1-Stage has high speed and low accuracy. However, recently, 1-Stage methods keep up with the speed of 2-Stage, and thus are gaining traction. An R-CNN is a 2-stage detector-type algorithm that adds a Region Proposal to a CNN to propose a place where an RPA input object is likely to be located, and then performs RPA input object detection in that region. There are four types of R-CNN series models, namely, R-CNN, Fast R-CNN, Faster R-CNN, and Mask R-CNN. R-CNN, Fast R-CNN, and Faster R-CNN are all models for RPA input object detection. Mask R-CNN is a model applied to instance segmentation by extending Faster R-CNN. Mask R-CNN is obtained by adding a CNN for masking whether each pixel is an RPA input object or not to Faster R-CNN. Mask R-CNN is known to exhibit better performance than previous models in all tasks of COCO challenges. FIG. 7D illustrates a process of training by applying Mask-RCNN from a screen subjected to training of FIG. 7A.

SSD (Single Shot MultiBox Detector), YOLO, DSSD (Deconvolutional Single Shot Detector), etc. are 1-stage Detector-type algorithms. 1-stage detector-type algorithms have an advantage of fast execution speed since proposal of a region where an RPA input object is likely to be present and RPA input objection detection are not divided and are simultaneously performed. Thus, in the embodiments of the present disclosure, the 1-stage detector or the 2-stage detector may be used depending on the application target.

YOLO is the first real-time RPA input object detector that solves slowness of 2-stage RPA input object detection models. In YOLO, feature maps are extracted through convolution layers, and bounding boxes and class probabilities may be predicted directly through fully connected layers. In addition, in YOLO, input images may be divided into S×S grids, and bounding boxes, confidence, and class probability maps corresponding to each grid region may be obtained.

In YOLO, an image is divided into grids and bounding boxes are predicted for each region. On the other hand, an SSD may be predicted using the CNN pyramidal feature hierarchy. In the SSD, image features may be extracted from layers at various positions to apply detectors and classifiers. The SSD exhibited higher performance than YOLO in terms of training speed, recognition speed, and accuracy. When performances of mask RCNN, YOLO, and SSD applied to the learning model for recognizing screen information based on AI and generating an event on an RPA input object on the screen are compared, mask RCNN has relatively high classification and localization accuracy, and has relatively low training speed and RPA input object recognition speed, YOLO has relatively low classification and localization accuracy, and has relatively high training speed and RPA input object recognition speed, and SSD has relatively high classification and localization accuracy, and has relatively high training speed and RPA input object recognition speed.

In order to improve performance in the existing SSD, deconvolution operation is added to DSSD to add context features. By adding deconvolution operation to the existing SSD, detection performance is increased while relatively maintaining the speed. In particular, for small RPA input objects, the VGG network used at the beginning of the SSD was replaced with Resnet-based Residual-101, and when testing on the network, the test time was reduced by 1.2 to 1.5 times by eliminating a batch normalization process.

An AI model is created through evaluation of the trained AI model. The trained AI model is evaluated using test data. Throughout the present disclosure, “trained AI model” means that a trained model is determined after training using training data and testing through the test data even when there is no specific mention.

The artificial neural network is an information processing system in which a plurality of neurons referred to as nodes or processing elements are connected in the form of a layer structure by modeling the operating principle of biological neurons and the connection relationship between neurons.

The artificial neural network is a model used in machine learning, and is a statistical learning algorithm inspired by neural networks in biology (particularly the brain in the central nervous system of animals) in machine learning and cognitive science.

Specifically, the artificial neural network may refer to an overall model that has problem-solving ability by changing synapse coupling strength through learning of artificial neurons (nodes) that form a network by synapse coupling.

The term artificial neural network may be used interchangeably with the term neural network.

The artificial neural network may include a plurality of layers, and each of the layers may include a plurality of neurons. In addition, the artificial neural network may include neurons and synapses connecting neurons.

The artificial neural network may be generally defined by an activation function generating an output value from the following three factors, namely, (1) connection patterns between neurons in different layers, (2) training process of updating weights of connections, and (3) weighted sum of inputs received from previous layers.

The artificial neural network may include network models of methods such as DNN (Deep Neural Network), RNN (Recurrent Neural Network), BRDNN (Bidirectional Recurrent Deep Neural Network), MLP (Multilayer Perceptron), CNN (Convolutional Neural Network), R-CNN, Fast R-CNN, Faster R-CNN, and mask-RCNN. However, the present disclosure is not limited thereto.

In this specification, the term “layer” may be used interchangeably with the term “class.”

Artificial neural networks are divided into single-layer neural networks and multilayer neural networks according to the number of classes.

A typical single-layer neural network includes an input layer and an output layer.

In addition, a general multilayer neural network includes an input layer, one or more hidden layers, and an output layer.

The input layer is a layer for receiving external data, the number of neurons of the input layer is the same as the number of input variables, and the hidden layers are located between the input layer and the output layer, receive signals from the input layer to extract features, and deliver the features to the output layer. The output layer receives signals from the hidden layers and outputs output values based on the received signals. Input signals between neurons are multiplied by connection strengths (weights), respectively, and summed. When this sum is greater than a threshold value of the neurons, the neurons are activated, and an output value received through an activation function is output.

Meanwhile, a deep neural network including a plurality of hidden layers between an input layer and an output layer may be a representative artificial neural network implementing deep learning, which is a type of machine learning technology.

The artificial neural network may be trained using training data. Here, training may refer to a process of determining parameters of the artificial neural network using training data in order to achieve a purpose such as classification, regression, or clustering of input data. As representative examples of parameters of the artificial neural network, a weight assigned to a synapse or a bias applied to a neuron may be cited.

An artificial neural network trained using training data may classify or cluster input data according to a pattern of the input data.

Meanwhile, an artificial neural network trained using training data may be referred to as a trained model in this specification.

Next, a learning method of the artificial neural network will be described.

Learning methods of the artificial neural network may be broadly classified into supervised learning, unsupervised learning, semi-supervised learning, and reinforcement learning.

Supervised learning is a method of machine learning for inferring a function from training data.

Among inferred functions, outputting continuous values may be referred to as regression, and inferring and outputting a class of an input vector may be referred to as classification.

In supervised learning, an artificial neural network is trained while a label for training data is given.

Here, the label may mean a correct answer (or a result value) to be inferred by the artificial neural network when training data is input to the artificial neural network.

In this specification, when training data is input, an answer (or a result value) to be inferred by the artificial neural network is referred to as a label or labeling data.

Further, in this specification, setting a label on training data for training the artificial neural network is referred to as labeling “labeling data” on training data.

In this case, training data and a label corresponding to the training data constitute one training set, and may be input to the artificial neural network in the form of the training set.

Meanwhile, the training data represents a plurality of features, and labeling the training data may mean that a label is attached to a feature represented by the training data. In this case, the training data may represent a feature of an input RPA input object in the form of a vector.

The artificial neural network may use the training data and the labeling data to infer a function for a correlation between the training data and the labeling data. In addition, parameters of the artificial neural network may be determined (adjusted) through evaluation of a function inferred from the artificial neural network.

A structure of the artificial neural network is specified by model configuration, activation function, loss function or cost function, learning algorithm, adjustment algorithm, etc., and a hyperparameter is set in advance before learning. Thereafter, a model parameter is set through learning, so that content may be specified.

For example, factors determining the structure of the artificial neural network may include the number of hidden layers, the number of hidden nodes included in each hidden layer, an input feature vector, a target feature vector, etc.

A hyperparameter includes various parameters that need to be initially set for training, such as an initial value of a model parameter. Further, the model parameter includes several parameters to be determined through training.

Examples of the hyperparameter may include an initial value of a weight between nodes, an initial value of a bias between nodes, a mini-batch size, the number of training iterations, a learning rate, etc. Further, examples of the model parameter may include a weight between nodes, a bias between nodes, etc.

The loss function may be used as an index (reference) for determining an optimal model parameter in a training process of the artificial neural network. In the artificial neural network, training means a process of manipulating model parameters to reduce the loss function, and the purpose of training may be regarded as determining model parameters that minimize the loss function.

The loss function may mainly use mean squared error (MSE) or cross entropy error (CEE), and the present disclosure is not limited thereto.

CEE may be used when the correct answer label is one-hot encoded. One-hot encoding is an encoding method in which a correct answer label value is set to 1 only for a neuron corresponding to the correct answer, and a correct answer label value is set to 0 for a neuron not corresponding to the correct answer.

In machine learning or deep learning, learning adjustment algorithms may be used to minimize the loss function, and learning adjustment algorithms include Gradient Descent (GD), Stochastic Gradient Descent (SGD), Momentum, Nesterov Accelerate Gradient (NAG), AdaGrad, AdaDelta, RMSProp, Adam, Nadam, etc.

GD is a technique for adjusting model parameters in a direction of reducing a value of the loss function by considering a slope of the loss function in a current state.

A direction of adjusting model parameters is referred to as a step direction, and a size of adjusting the model parameters is referred to as a step size.

In this instance, the step size may mean a learning rate.

GD may be updated by partially differentiating the loss function with each model parameter to obtain a slope, and changing the model parameters by the learning rate in a direction of the obtained slope.

SGD is a technique that increases a frequency of gradient descent by dividing the training data into mini-batches and performing GD for each mini-batch.

AdaGrad, AdaDelta, and RMSProp are techniques that increase adjustment accuracy by adjusting the step size in SGD. In SGD, momentum and NAG are techniques that increase adjustment accuracy by adjusting the step direction. Adam is a technique that increases adjustment accuracy by combining momentum and RMSProp to adjust the step size and the step direction. Nadam is a technique that increases adjustment accuracy by combining NAG and RMSProp to adjust the step size and the step direction.

The training speed and accuracy of the artificial neural network are characterized by being largely dependent on the hyperparameters as well as the structure of the artificial neural network and the type of learning adjustment algorithm.

Therefore, in order to obtain an excellent learning model, it is important not only to determine an appropriate artificial neural network structure and learning algorithm, but also to set appropriate hyperparameters.

Conventionally, hyperparameters are experimentally set to various values to train the artificial neural network, and are set to optimal values that provide stable training speed and accuracy as a result of training.

FIG. 5 is an exemplary diagram illustrating a result of inferring a position of an RPA input object through an AI model trained on a browser screen.

A position 401 of a search bar of a browser is specified as a result of training the AI screen learning model of FIG. 4 from the screen image of FIG. 5. In order to generate an event of clicking other icons in the corresponding site of the browser in addition to an event of specifying a position of an RPA input object, which is an input window of the search bar 401, positions of icons may be specified as a result of training the trained AI screen learning model using the icons to be clicked by setting data of RPA input objects and data specifying positions of the RPA input objects as a training data set.

FIG. 6 is an exemplary diagram illustrating a result of inferring a position of an RPA input object through a trained AI model on a PC desktop.

Even when there is a plurality of search boxes and chat windows, positions of a desired search bar 401, a login 410, a company name 420, an ID 430, and a password 440, which are RPA input objects, may be specified.

FIG. 7A is an exemplary diagram illustrating a screen for training an AI model configured to infer a position of an RPA input object on the screen according to FIG. 4.

The user PC screen serves as a screen image 400 to be trained. The AI screen agent 110 may transmit the user PC screen image 400 to the AI screen 230 of the Web-based IT operation management system platform 200, and request information data obtained by inferring a position of an RPA input object on the screen from the AI screen 230 including the trained AI model 232 (S308).

FIG. 7B is an exemplary diagram of labeling an RPA input object on the screen for training the AI model configured to infer a position of an RPA input object on the screen according to FIG. 4.

A data processor 234 receives the screen image 400 from the user PC and performs labeling of RPA input objects such as the login 410, the company name 420, the ID 430, and the password 440.

In another embodiment, a data set in which data of the screen image 400 and positions of respective RPA input objects for the screen image 400 are labeled may be provided from another database.

FIG. 7C is an exemplary diagram of a result of actually recognizing an RPA input object after training the AI model configured to infer a position of an RPA input object on the screen according to FIG. 4.

The AI screen 230 transmits a position of an RPA input object through a trained AI screen learning model.

FIG. 7D is an exemplary diagram illustrating a process of training by applying a mask-RCNN from a screen for training of FIG. 7A.

In the screen image 400 of FIG. 7D, an existing Faster RCNN process is executed to detect an RPA input object. In the existing Faster RCNN, RoI pooling is a model for RPA input object detection, and thus it is not important to contain accurate position information. Therefore, when RoI has decimal point coordinates, the coordinates are rounded off and then pooling is performed. Position information is important at the time of masking (segmentation) since position information is distorted when decimal points are rounded off. Therefore, RoI align, which contains position information using bilinear interpolation, is used. A feature map is extracted using conv by RoI align, RoI is extracted from the feature map and classified by class, and RPA input objects are detected by performing masking in parallel.

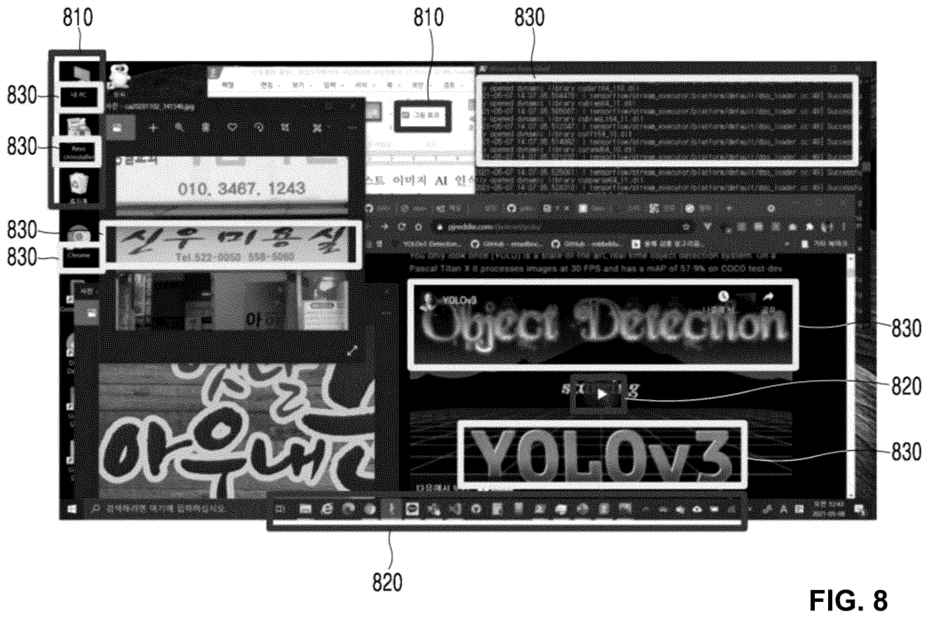

FIG. 8 is an example diagram illustrating screen information including text and non-text images 810, non-text images 820, and text images 830. Recognition of an RPA input object on a screen through the AI models of FIGS. 1 to 7D is possible by clicking on an event through screen UI recognition by recognition of the non-text images 820. However, when the text images 830 are included in a UI image, there is a limitation in that content of the text images 830 cannot be recognized, and similar text having different text content is recognized as the same text image. In this case, only a half-screen recognition function is provided, and thus improvement is necessary. This problem may be solved by constructing an AI model for complex recognition of shape images and text to recognize the UI images 810 including text and non-text (also referred to as “text and non-text images”).

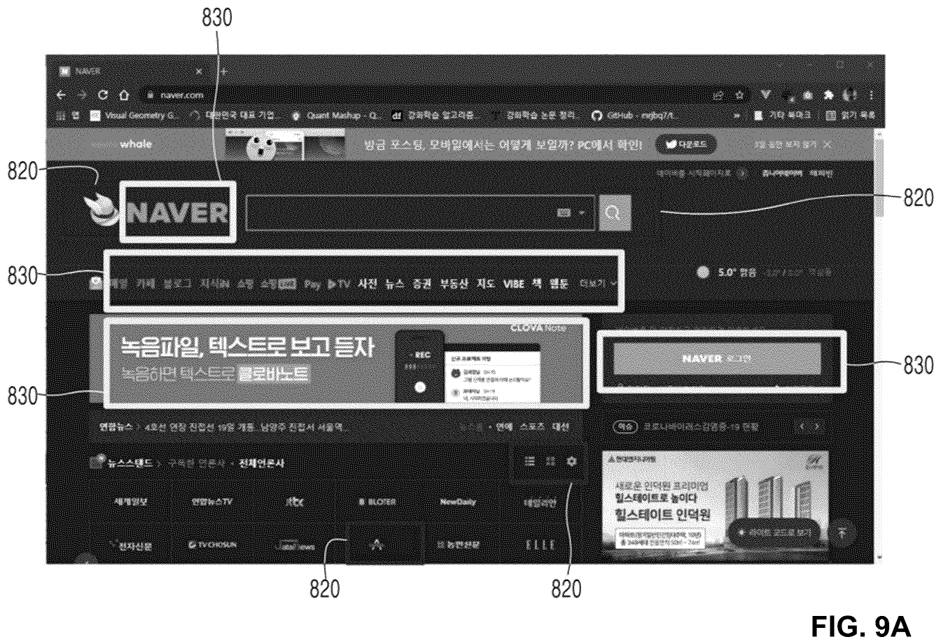

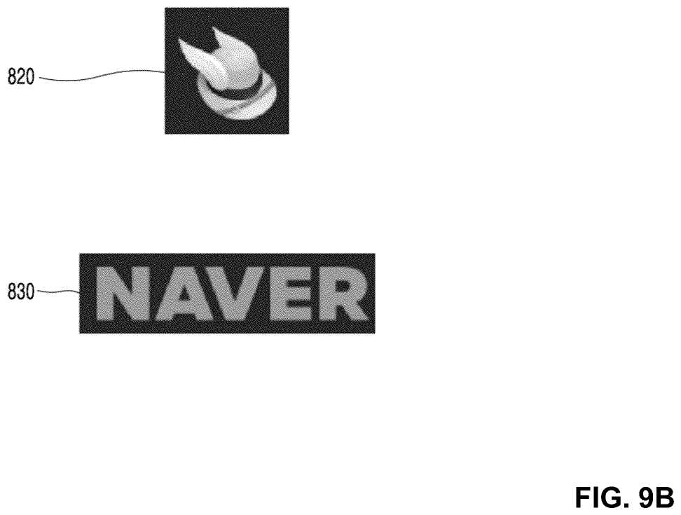

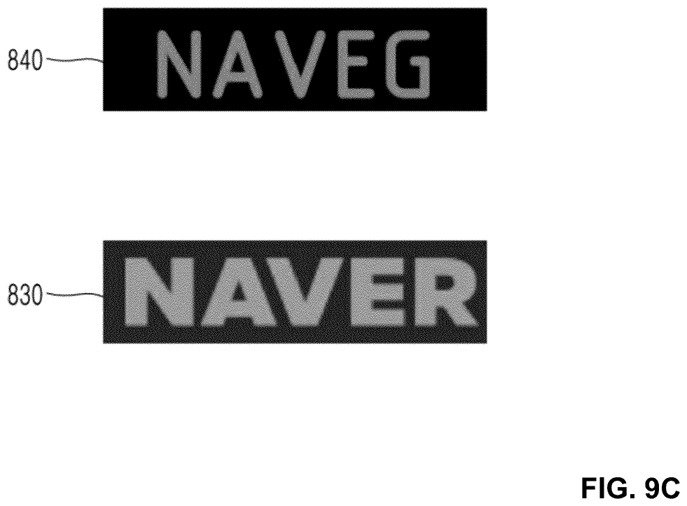

FIG. 9A is an example diagram illustrating screen information of a specific portal site including the non-text images 820 and the text images 830. The screen UI may recognize only classes (Naver hat icon, search magnifying glass, etc.) registered by being learned in advance using RPA input object detection. The Naver hat icon and the search magnifying glass are examples of the non-text images 820, and banner advertisement, a: login window, and a menu button including text are examples of the text images 830. The text in the banner advertisement and the text in the menu cannot be learned in advance using RPA input object detection. Therefore, to solve this problem, a text box RPA input object (also referred to as class) may be recognized through an RPA input object detector as a first step, and then text may be recognized using a C-RNN model as a second step.

FIG. 9B is an example diagram illustrating a case where screen UI images are distinguished based on RPA input object detection according to an embodiment of the present invention. When a UI image includes a non-text image (a hat image) and a text image (text “NAVER”), a screen UI recognition model utilizing existing RPA input object detection may distinguish each of the non-text images 820 and each of the text images 830 as two different images. However, the screen UI recognition model utilizing existing RPA input object detection may recognize the text image (NAVER image) only as a text box (text class) without knowing content of the text.

FIG. 9C is an example diagram illustrating text images that cannot be distinguished only by RPA input object detection according to an embodiment of the present invention. When a text image 830 and a similar text image 840 are entered together, the screen UI recognition model cannot correctly distinguish between the two different images (NAVER and NAVEG). A reason therefor is that, an RPA input object detection model recognizes RPA input objects having similar shapes or forms as the same RPA input object. Therefore, all RPA input objects in a screen may be correctly recognized when not only a screen UI but also content of a text image are recognizable.

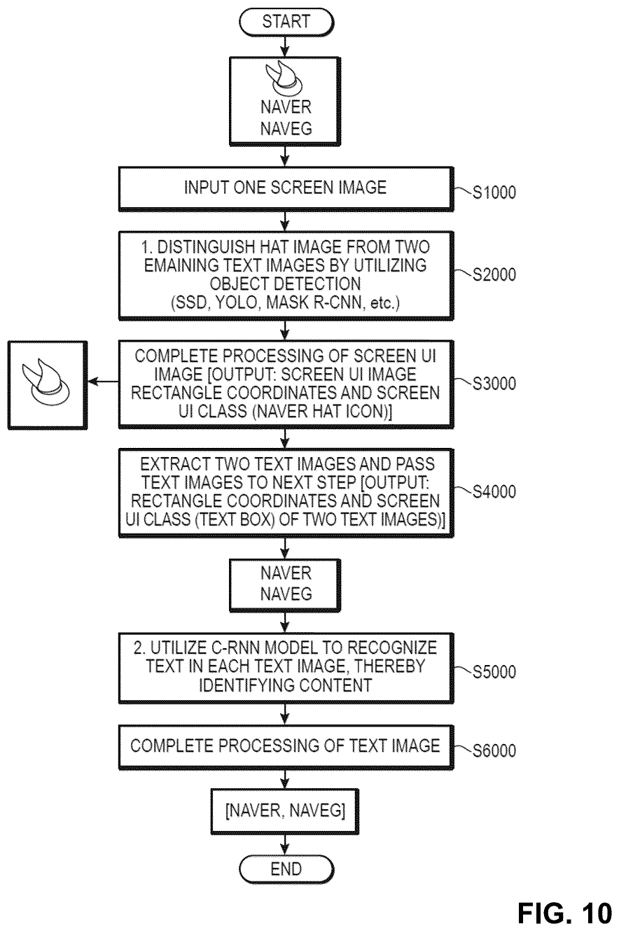

FIG. 10 is an example diagram illustrating a process of recognizing a text image from a screen image including text and non-text images according to an embodiment of the present invention.

Upon reception of one screen image including a non-text UI and a text image, a non-text UI and text image composite recognition model may perform image recognition broadly in two steps of 1) step S2000 of distinguishing a hat image of a non-t×t image part from two remaining text images by utilizing RPA input object detection (SSD, YOLO, Mask R-CNN, etc.) and 2) step S5000 of utilizing a text recognition AI model such as a C-RNN model to recognize text in each text image, thereby identifying content (830-NAVER and 840-NAVEG). In another embodiment of the present invention, the text recognition AI model is not limited to C-RNN, and another AI model for recognizing text may be used. A flow of a non-text UI and text image composite recognition model that comprehensively recognizes non-text UI and text images and generates an event for an RPA input object on a screen according to an embodiment of the present invention is as follows.

The non-text UI and text image composite recognition model receives one non-text image and one text image as input (S1000). When the non-text UI and text image composite recognition model receives only a non-text UI image 820, recognition may be possible from an RPA input object detector that recognizes a screen UI.

The non-text UI and text image composite recognition model may distinguish between a hat image in a non-text image part and remaining two text images by utilizing RPA input object detection (SSD, YOLO, Mask R-CNN, etc.) (S2000).

The non-text UI and text image composite recognition model may complete recognition processing of the non-text UI image 820 by utilizing RPA input object detection (S3000). RPA input object detection of the non-text UI and text image composite recognition model may output rectangle coordinates and a non-text screen UI class (Naver hat icon) to the non-text UI image.

The non-text UI and text image composite recognition model recognizes and extracts two text images 830 and 840 as text boxes and passes the text images to the next step (S4000). RPA input object detection may output the rectangle coordinates and screen UI class (text box) of the two text images 830 and 840.

The non-text UI and text image composite recognition model utilizes the C-RNN model to recognize text in each text image, thereby identifying content (830-NAVER and 840-NAVEG) (S5000). The C-RNN model may accurately recognize text in a text box. A C-RNN is a structure that first calculates a CNN, then divides each channel, and performs input to the RNN. This may be regarded as a flow of extracting a feature through the CNN and classifying the feature using the RNN.

The non-text UI and text image composite recognition model recognizes text in text images and completes text image processing (S6000).

When the “non-text UI and text image composite recognition model” of FIG. 10 is introduced into the “method of generating an event for an RPA input object on a screen by recognizing screen information based on AI”, the AI model of the AI screen may output result data obtained by inferring an RPA input object position at which an event for the RPA input object is to be generated on the entire screen using, as training data, positions of RPA input objects labeled on images of the entire screen and UI images including text and non-text of the entire screen, and a step of inferring a position of an RPA input object of a screen using a trained AI model of the AI screen from a screen image including text and non-text images received by the AI screen may include a step (first step) of distinguishing between a part including text and a part which is not text in a UI image including text and non-text, and a step (second step) of recognizing text from a part of the UI image including text in order to detect the UI image including the text and the non-text.

In another embodiment of the present invention, a RPA input object detector, which detects an RPA input object in a screen, may output result data obtained by inferring an RPA input object position at which an event for an RPA input object is to be generated on the entire screen using, as training data, positions of RPA input objects labeled in images on the entire screen and UI images including text and non-text of the entire screen using an AI model trained from the AI model learner, and the AI model may distinguish between a part including text and a part which is not text in the UI images including the text and non-text and recognize text from a part of the UI images including the text in order to detect the UI images including the text and non-text.

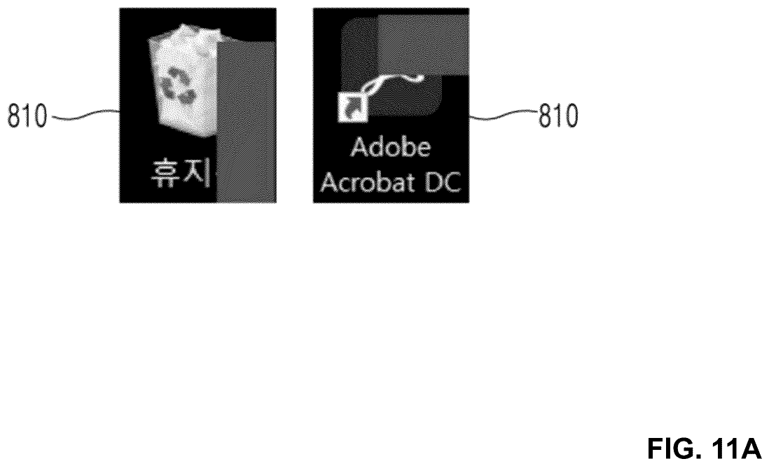

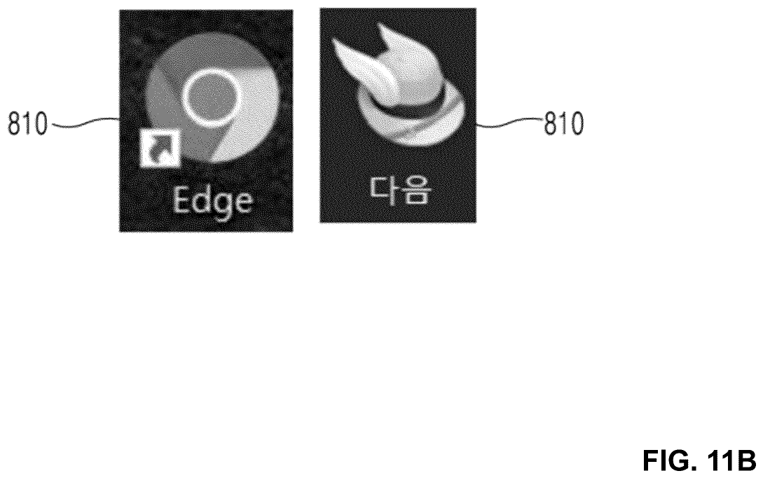

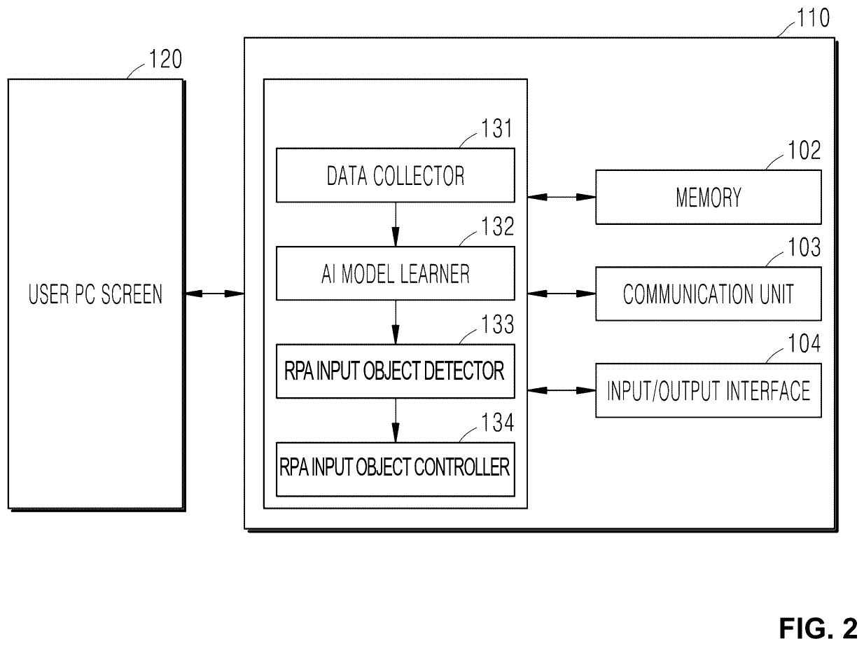

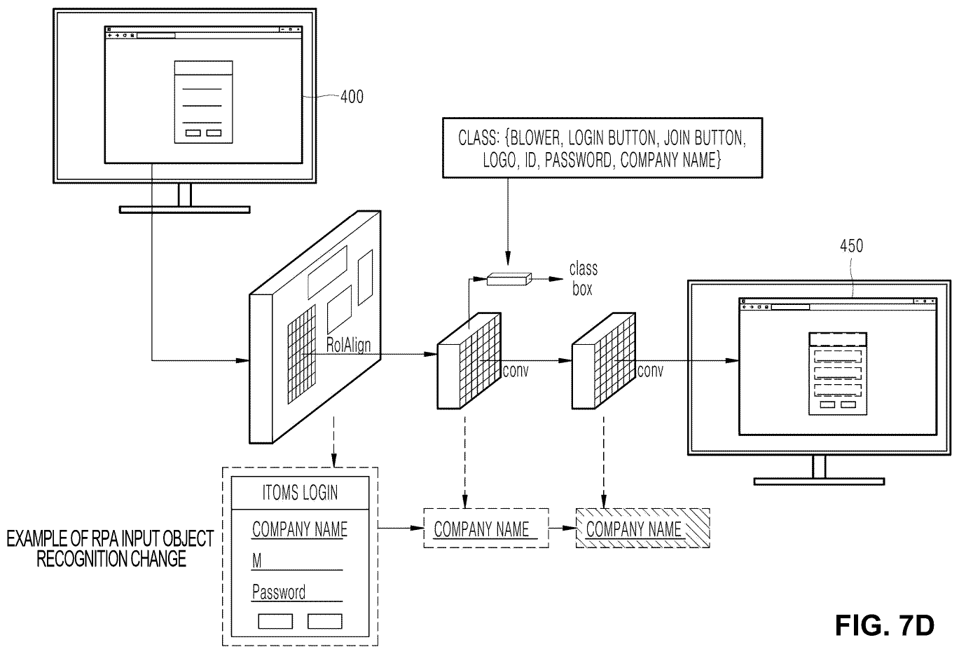

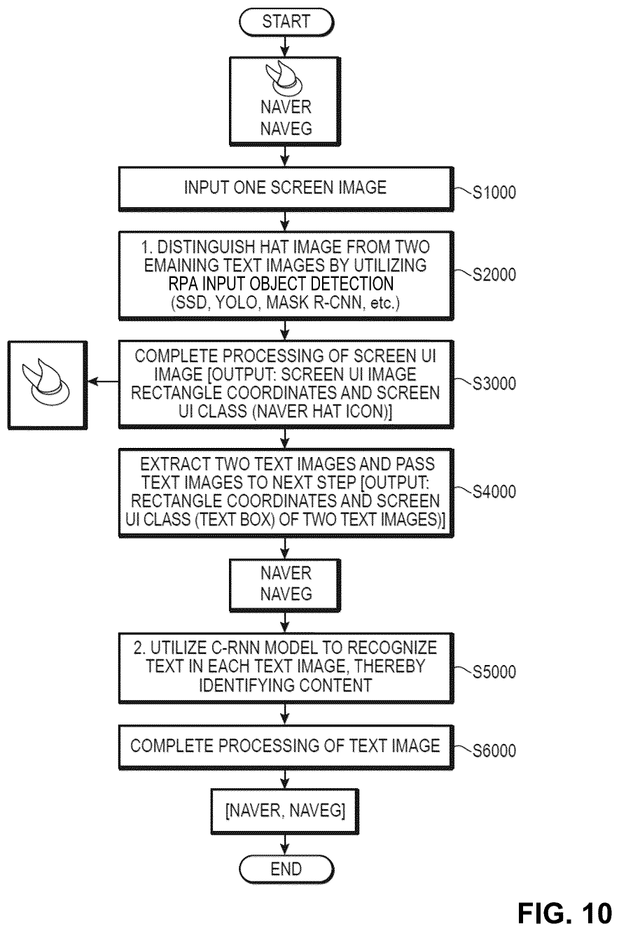

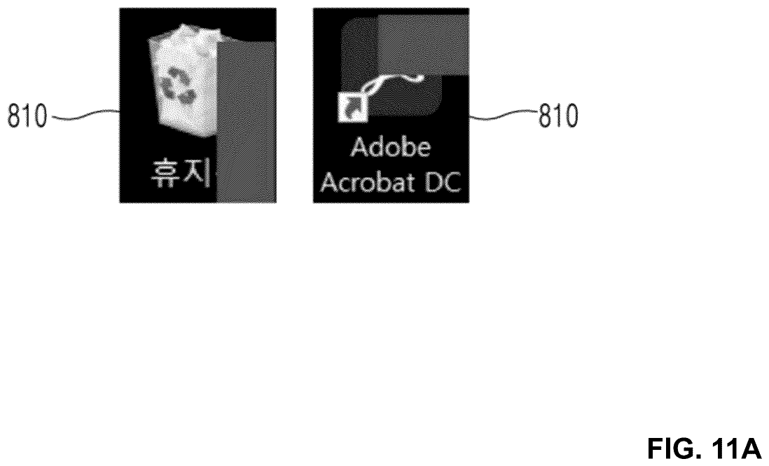

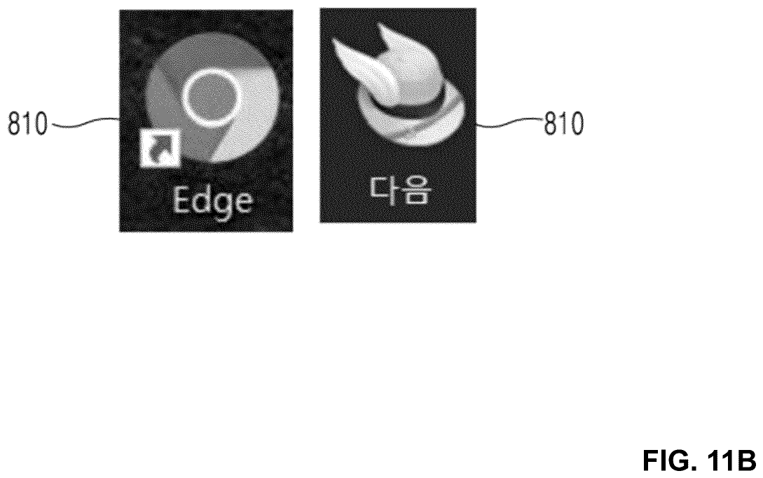

FIG. 11A is an diagram illustrating a case where misrecognition is reduced by recognizing a text image from a screen image including text and non-text images according to an embodiment of the present invention. Even when there is an error in a UI including both a non-text UI and a text image, and thus a portion of a non-text part or a text part cannot be recognized, the non-text UI text image composite recognition model may recognize a correct UI from a recognizable non-text part or text part.

FIG. 11B is an example diagram illustrating a case where a text image may be recognized as error information from a screen image including text and non-text images according to an embodiment of the present invention. As in FIG. 11B, when there is an error in a text part corresponding to a non-text UI image part or when there is an error in a non-text UI part corresponding to a text part, the non-text UI and text image composite recognition model may recognize this as error information.

An embodiment according to the present disclosure described above may be implemented in the form of a computer program that may be executed on a computer through various components, and such a computer program may be recorded on a computer-readable medium. At this time, the medium may include a magnetic medium such as a hard disk, a floppy disk or a magnetic tape, an optical recording medium such as a CD-ROM or a DVD, a magneto-optical medium such as a floptical disk, and a hardware device specially configured to store and execute a program instruction, such as a ROM, a RAM, and a flash memory.

Meanwhile, the computer program may be specially designed and configured for the present disclosure, or may be available by being known to those skilled in the art of computer software. Examples of the computer program may include not only machine language code generated by a compiler but also high-level language code executable by a computer using an interpreter, etc.

In the specification n of the present disclosure (especially in the claims), the use of the term “the” and similar indicating terms may correspond to both singular and plural. In addition, when a range is described in the present disclosure, the invention, to which each h individual value within the range is applied, is included (unless there is a statement to the contrary), which is the same as describing each individual value included in the range in the detailed description of the invention.

When there is no explicit order or description to the contrary for steps included in a method according to the present disclosure, the steps may be performed in an appropriate order. The present disclosure is not necessarily limited according to the described order of the steps. In the present disclosure, the use of any examples or exemplary terms (for example, etc.) is merely intended to describe the present disclosure in detail, and the scope of the present disclosure is not limited by the above examples or exemplary terms unless limited by the claims. In addition, those skilled in the art may appreciate that various modifications, combinations and changes may be made according to design conditions and factors within the scope of the appended claims or equivalents thereto.

Therefore, the spirit of the present disclosure should not be determined by being limited to the above-described embodiments, and not only the claims to be described later, but also all scopes equivalent to or equivalently changed from the scope of the claims fall within the scope of the spirit of the present disclosure.
100: user PC 102: memory
103: communication unit 104: input/output interface
110: AI screen agent 112: AI Web socket
120: user PC screen 131: data collector
132: AI model learner 133: RPA input object classifier
134: RPA input object controller 200: IT operation management system platform
210: IT operation management system homepage 212: scheduler button
222: AI Web socket 230: IT operation management system AI screen 232: AI screen learning model 234: data processor
810: image having text and non-text 820: non-text image 830: text image 840: similar text image

1. A method of generating an event for an RPA input object on a screen by recognizing screen information including images having text and non-text based on artificial intelligence (AI) in Robotic Process Automation (RPA), the RPA input object including an input position on the screen that can be activated by an input device on the screen, the method comprising:
accessing a Web-based IT operation management system platform from a PC to register a schedule in a scheduler;
reporting start of the scheduler from the Web-based IT operation management system platform to an AI screen agent of the PC through communication at a predetermined time;
transmitting, by the AI screen agent, a screen image of the PC including images having text and non-text to an AI screen of the Web-based IT operation management system platform, and requesting information data obtained by inferring a position of an RPA input object on the screen from the AI screen including an AI model trained using an RPA input object position from a screen image;
inferring, by the AI screen, a position of an RPA input object on the screen through the trained AI model of the AI screen from the screen image including the received images having the text and non-text;
transmitting information data for the inferred position of the RPA input object to the AI screen agent through communication; and
generating, by the AI screen agent, an event for the RPA input object on the screen of the PC based on the transmitted data,
wherein the AI model of the AI screen outputs result data obtained by inferring an RPA input object position at which an event of an RPA input object is to be generated on the entire screen using, as training data, images of the entire screen and positions of RPA input objects labeled on images having text and non-text on the entire screen, and
the inferring, by the AI screen, a position of an RPA input object on the screen through the trained AI model of the AI screen from the screen image including the received images having the text and non-text comprises distinguishing between a part including the text and a part which is not the text in the images having the text and non-text so that the AI model of the AI screen detects the images having the text and non-text, and recognizing text from a part of the image including the text.

2. The method according to claim 1, wherein:
in the inferring a position of an RPA input object on the screen through the trained AI model of the AI screen, the AI model is trained to perform a function of an RPA input object detector configured to provide information on what type of RPA input object is present (classification) at which position (localization) on one screen in order to distinguish between a part including the text and a part which is not the text in the images having the text and non-text, and
the RPA input object detector is a 1-stage detector configured to simultaneously perform a localization stage and a classification stage.

3. The method according to claim 2, wherein the 1-stage detector is an SSD (Single Shot MultiBox Detector), a YOLO detector, or a DSSD (Deconvolutional Single Shot Detector).

4. The method according to claim 1, wherein the input position of the RPA input object includes a text input position or a mouse input position where information input is possible.

5. A method of generating an event for an RPA input object on a screen by recognizing screen information including images having text and non-text based on AI in a PC including an AI screen agent in Robotic Process Automation (RPA), the RPA input object including an input position on the screen that can be activated by an input device on the screen, the method comprising:
inferring, by an AI screen, a position of an RPA input object on the screen through a trained AI model of the AI screen from a screen image, the AI screen agent in the PC including the AI screen having the AI model trained using the RPA input object position from the screen image including the images having text and non-text of the PC; and
generating, by the AI screen agent, an event for an RPA input object on the screen of the PC based on the position of the RPA input object inferred by the AI screen in the AI screen agent, wherein:
the AI model of the AI screen outputs result data obtained by inferring an RPA input object position at which an event for the RPA input object is to be generated from the entire screen using, as training data, a position of the RPA input object labeled in images of the entire screen and images including text and non-text of the entire screen, and
the inferring, by an AI screen, a position of an RPA input object on the screen through a trained AI model of the AI screen from a screen image comprises distinguishing between a part including the text and a part which is not the text in the images having the text and non-text so that the AI model of the AI screen detects the images having the text and non-text, and recognizing text from a part of the image including the text.

6. The method according to claim 5,
wherein the input position of the RPA input object includes a text input position or a mouse input position where information input is possible.

7. The method according to claim 5, wherein:
in the inferring, by an AI screen, a position of an RPA input object on the screen through a trained AI model of the AI screen from a screen image, the AI model is trained to perform a function of an RPA input object detector configured to provide information on what type of RPA input object is present (classification) at which position (localization) on one screen in order to distinguish between a part including the text and a part which is not the text in the images having the text and non-text, and
the RPA input object detector is a 2-stage detector configured to sequentially perform a localization stage of finding a position where the RPA input object is present and a classification stage of checking an RPA input object present at the found position (local), or is a 1-stage detector configured to simultaneously perform the localization stage and the classification stage.

8. (canceled)

9. A computer-readable recording medium storing a program programmed to perform the method of generating an event for an RPA input object on a screen according to claim 1 using a computer.

10. A Robotic Process Automation (RPA) system for generating an event for an RPA input object on a screen by recognizing screen information based on AI, the RPA input object including an input position on the screen that can be activated by an input device on the screen, the system comprising:
a PC comprising an AI screen agent; and
a server comprising a Web-based IT operation management system platform, wherein:
the AI screen agent accesses the Web-based IT operation management system platform to register a schedule in a scheduler,
the server transmits data reporting start of the scheduler from the Web-based IT operation management system platform to an AI screen agent of the PC through communication at a predetermined time,
the AI screen agent of the PC transmits a screen image of the PC including images having text and non-text to an AI screen of the Web-based IT operation management system platform, and requests information data obtained by inferring a position of one or more RPA input objects on the screen from the AI screen including an AI model trained using an RPA input object position from a screen image,
the AI screen infers a position of an RPA input object on the screen through the trained AI model of the AI screen from the screen image including the received images having the text and non-text, and transmits information data for the inferred position of the RPA input object to the AI screen agent through communication,
the AI screen agent generates an event for one or more RPA input objects on the PC screen based on the transmitted data,
the trained AI model outputs result data obtained by inferring an RPA input object position at which an event of an RPA input object is to be generated on the entire screen using, as training data, images of the entire screen and positions of RPA input objects labeled on images having text and non-text on the entire screen, and
the AI model of the AI screen distinguishes between a part including the text and a part which is not the text in the images having the text and non-text to detect the images having the text and non-text, and recognizes text from a part of the image including the text.

11. An RPA input object control device for generating an event for an RPA input object on a screen by recognizing screen information based on AI in a computer, the RPA input object including an input position on the screen that can be activated by an input device on the screen, the RPA input object control device comprising an AI screen agent, wherein:
the AI screen agent comprises:
a data collector configured to cause a position of an RPA input object displayed on a computer screen including images having text and non-text to be learned, and to collect data on the entire screen and position data of the RPA input object displayed on the screen including images having text and non-text from a display device of the computer to generate an event for the RPA input object;
an AI model learner trained through a deep neural network based on collected data;
an RPA input object detector configured to detect an RPA input object in the screen based on a result of training in the AI model learner; and
an RPA input object controller configured to generate an event for an RPA input object based on an RPA input object position on the entire screen detected and classified in the RPA input object detector,
an AI model trained from the AI model learner outputs result data obtained by inferring an RPA input object position at which an event of an RPA input object is to be generated on the entire screen using, as training data, images of the entire screen and positions of RPA input objects labeled on images having text and non-text of the entire screen, and
the AI model distinguishes between a part including the text and a part which is not the text in the images having the text and non-text to detect the images having the text and non-text, and recognizes text from a part of the image including the text.

12. The screen RPA input object control device according to claim 11, wherein:
the AI model is trained to perform a function of an RPA input object detector configured to provide information on what type of RPA input object is present (classification) at which position (localization) on one screen to distinguish between a part including the text and a part which is not the text in the images having the text and non-text; and
the AI model utilizes a C-RNN model to recognize text from a part of the image including the text.

13. The RPA input object control device according to claim 10, wherein the input position of the RPA input object includes a text input position or a mouse input position where information input is possible.
